(19) United States
(12) Patent Application Publication
(10) Pub. No.: US 2006/0080362 A1
(43) Pub. Date: Apr. 13, 2006

(54) Data Synchronization Over a Computer Network

(75) Inventors: David B. Wagner, Boulder, CO (US); Mark G. Hayden, Fairfield, CA (US)

Correspondence Address: KENNETH C. WINTERTON;HOLLAND & HART LLP, P. O. BOX 8749, DENVER, CO, 80201-8749, US

(73) Assignee: LEFTHAND NETWORKS, INC., Boulder, CO (US)

(21) Appl. No.: 10/711,893

(22) Filed: Oct. 12, 2004

(51) Int. Cl. G06F 17/30

(52) U.S. Cl. 707/200

(57) ABSTRACT

A method for copying data and a data storage system including a primary data storage system and a remote data storage system stores data and copies data between the primary and remote systems with enhanced performance. The primary data storage system includes a primary data storage volume, and primary snapshots comprising data stored at the primary volume since a previous primary snapshot. The remote system includes a remote volume comprising a pointer to one or more remote snapshots, the remote snapshots corresponding to the primary snapshots. In the event of a failure at the primary system, the remote volume is made into a new primary volume and data from the remote snapshots is used for read and write operations in place of the primary volume. When the primary volume recovers from the failure, the new primary volume may be resynchronized with the primary volume.

### FIELD OF THE INVENTION

The present application relates to data storage, and, in particular, to the replication of data in a network data storage system for business continuance, backup and recovery, data migration, and data mining.

### BACKGROUND OF THE INVENTION

Conventional network computer systems are generally comprised of a number of computers that each have an operating system, a network for communicating data between the computers, and one or more data storage devices attached to one or more of the computers but not directly attached to the network. In other systems network attached storage devices are used in order to enhance efficiency of data transfer and storage over a network. The network attached storage devices are directly attached to a network and are dedicated solely to data storage. Due to this direct attachment, any computer in the networked computer system may directly communicate with the network attached storage device. In many applications it is highly desirable to have redundant copies of data stored on the network.

While having redundant copies of data is often desirable in order to maintain access to the data in the event of one or more failures within a network or any storage device, the creation and maintenance of redundant copies can require and consume significant system resources. For example, some data storage systems use mirroring between storage systems located at different sites to maintain redundant copies of data. In such a system, a first data storage device at a first location is coupled to a second data storage system at a second location. In some cases, this coupling is accomplished by a dedicated high-speed link. When the first data storage system receives data to be written to the storage device from a host application, the data is transmitted to the second data storage system and written to the first data storage location and the second data storage location. In such systems, the first data storage system typically does not report to the host application that the data has been successfully stored until both the first data storage system has stored the data and a confirmation has been received that the second data storage system has stored the data. Such a system helps to maintain redundant copies of data in two different locations, but requires a relatively high amount of overhead and generally has reduced performance compared to a data storage system that is not required to transmit data to a second system and receive a confirmation that the data has been written at the second system.

Other types of systems seek to maintain redundant copies of data through creation of intermittent backup copies of data stored at the system. Such a backup copy may be, for example, a daily backup of data to tape data cartridges. While such systems generally have reduced system requirements compared to systems using mirroring operations, if a failure occurs at the storage system after data has been modified and not backed up, the modified data may be lost.

### SUMMARY OF THE INVENTION

The present invention has recognized that a significant amount of resources may be consumed in generating copies of data stored at a data storage volume within a data storage system. The resources consumed in such operations may be computing resources associated with a generating and maintaining copies, and/or network resources used to connect data storage devices and host applications. A significant amount of such resources may be associated with the host computer waiting to receive an acknowledgment that the data has been written to the storage device. This wait time is a result of the speed and efficiency with which the data storage system stores data. Furthermore, the wait time may be increased as the distance between data storage locations maintaining copies of data. However, distance between storage locations maintaining copies of data is often desirable in order to gain enhanced disaster recovery options.

The present invention reduces the adverse effects of this resource consumption when generating copies of data stored in a data storage system by reducing the amount of computing and network resources required to generate and maintain copies of data. Consequently, in a network data storage system utilizing the present invention, computing and network resources are preserved, thus enhancing the efficiency of the data storage system.

In one embodiment, the present invention provides a system for use in providing remote copy data storage of data over a computer network. The system comprises (a) a storage server system comprising one or more data storage servers that each comprise a data storage device and a network interface, each of the data storage servers operable to communicate over the network interface with at least one application client that will require data storage and at least one other data storage server; and (b) a data management system comprising at least one data management server operable. The data management server is operable to (a) define at least a first and a second cluster each comprising one or more data storage servers, (b) define at least one primary volume of data storage distributed over at least two storage servers within one of the clusters, the primary volume storing data from the application client, (c) define at least one remote volume of data storage distributed over one or more of the storage servers within one of the clusters; (d) create snapshots of the primary volume; and (e) copy data from the snapshots over the computer network to the remote volume. In an embodiment, each of the snapshots provides a view of the data stored at the primary volume at the point in time of the snapshot. An application client may read data stored in the snapshots at the primary volume, and in an embodiment may read data stored in the snapshots at the remote volume. In one embodiment, each snapshot of the primary volume includes data that has been modified at the primary volume since a previous snapshot of the primary volume. The data management system can copy data from the snapshots to the remote volume independently of network protocol, independently of network link bandwidth, and/or independently of network latency.

The present invention also, in an embodiment, provides a system in which the snapshots are copied from the primary volume to the remote volume and at least a second remote volume distributed over one or more storage servers within one of the clusters. The source of the snapshots copied to the second remote volume may be selected based on one or more of: (a) the volume most likely to be available, (b) the least loaded volume, (c) the volume with the highest bandwidth connection to the network, (d) and the volume with a less costly connection to the network as compared to other volumes. The snapshots may also be copied from the primary volume to the remote volume, and them copied from the remote volume to the second remote volume. In another embodiment, snapshots of the primary volume are created according to a predetermined schedule defined by the data management system. The snapshots of the primary volume may be copied to remote snapshots associated with the remote volume according to the same predetermined schedule, according to a different schedule, or according to no schedule.

In another embodiment, the data management system is further operable to designate the primary volume as a second remote volume that is not able to write data from application clients. The data management system, in another embodiment, is operable to designate the remote volume as a second primary volume, the second primary volume storing data from at least one application client independently of the primary volume. The remote volume may be designated as the second primary volume following a failure of the primary volume, or the remote volume may be designated as the second primary volume following a determination by a user to create a second primary volume.

The primary volume, in yet another embodiment, comprises a plurality of logical blocks of data. Each of the plurality of logical blocks of data comprises a plurality of physical blocks of data, each physical block of data comprising a unique physical address associated with the data storage device and data to be stored at the unique physical address. In this embodiment, the snapshots may comprise pointers to logical blocks of data stored at the cluster. Each of the logical blocks of data are copied from the primary volume to the remote volume and at least a second remote volume distributed over one or more storage servers within one of the clusters, and wherein the source of each of the logical blocks of data copied to the second remote volume is selected based on one or more of: (a) the volume most likely to be available, (b) the least loaded volume, (c) the volume with the highest bandwidth connection to the network, and (d) the volume with a less costly connection to the network as compared to other volumes.

In yet another embodiment, the data management system is operable to copy data from the snapshots to the remote volume at a selected maximum bandwidth. The selected maximum bandwidth may be adaptively set based on the network bandwidth capacity and utilization of the network. The selected maximum bandwidth may also be adjusted based on time of day. In still a further embodiment, the data management server is a distributed data management server distributed over one or more data storage servers. The data management server may also redefine the primary volume to be distributed over one or more data storage servers that are different than the data storage servers originally having the primary volume while copying data from the snapshots over the computer network to the remote volume. The data management server is also operable, in an embodiment, to define at least one replica volume of data storage distributed over one or more data storage servers within one of the clusters, the replica volume storing data stored at the primary volume. The data management server may create snapshots of the replica volume corresponding to the snapshots of the primary volume. The source of the snapshots copied to the remote volume may be selected based on one or more of: (a) the volume most likely to be available, (b) the least loaded volume, (c) the volume with the highest bandwidth connection to the network, and (d) the volume with a less costly connection to the network as compared to other volumes.

In another embodiment, the present invention provides a method for copying data from a primary volume to a remote location. The method comprises (a) defining a first primary volume of data storage distributed over at least two data storage servers within a first cluster of data storage servers; (b) generating a first primary snapshot of the first primary volume, the first primary snapshot providing a view of data stored at the first primary volume at the time the first primary snapshot is generated; (c) creating a first remote volume distributed over one or more data storage servers within a cluster of data storage servers; (d) linking the first remote volume to the first primary volume; and (e) copying data from the first primary snapshot to a first remote snapshot associated with the first remote volume. The method also includes, in one embodiment, (f) generating a second primary snapshot of the first primary volume, the second primary snapshot providing a view of data stored at the first primary volume at the time the second primary snapshot is generated; and (g) copying data from the second primary snapshot to a second remote snapshot associated with the first remote volume. The second primary snapshot includes data that has been modified at the first primary volume since the step of generating a first primary snapshot. In another embodiment, the steps of generating first and second primary snapshots are performed according to a predetermined schedule defined by a data management system.

In a further embodiment, the method also includes the step of designating the first remote volume as a second primary volume. The second primary volume stores data from at least one application client independently of the first primary volume. The step of designating may be performed following a failure of the first primary volume, and/or following a determination by a user to create a second primary volume. Furthermore, the first primary volume may be designated as a second remote volume that is not able to write data from application clients. In still another embodiment, the method further includes the step of resynchronizing the second primary volume with the second remote volume. The step of resynchronizing includes, (i) generating a second primary snapshot of the second primary volume providing a view of data stored at the second primary volume at the time the second primary snapshot is generated; (ii) generating a second remote snapshot of the second remote volume providing a view of data stored at the first primary volume at the time the second remote snapshot is generated; and (iii) copying data that has been modified at the second primary volume to the second remote volume.

In another embodiment, the method for copying data from a primary data storage volume to a remote data storage volume in a distributed data storage system also includes the step of copying data from the first snapshot to both the first remote volume and a second remote volume distributed over one or more storage servers within a cluster of data storage servers. The step of copying data from the first snapshot to a second remote volume may include copying data from the first remote snapshot to the second remote volume.

### BRIEF DESCRIPTION OF THE DRAWINGS

FIG. 1 is a block diagram representation of a network system including network attached storage according to an embodiment of the present invention;

FIG. 2 is a block diagram representation of management groups, clusters, and volumes within a network system of an embodiment of the present invention;

FIG. 3 is a block diagram representation of a primary volume, a primary snapshot, a remote volume, and a remote snapshot for an embodiment of the present invention;

FIG. 4 is a block diagram representation of a source location and multiple destination locations for copying data from the source location for an embodiment of the present invention;

FIGS. 5A and 5B are a block diagram illustrations of pages of data within volumes and snapshots and how the pages are copied for an embodiment of the present invention;

FIG. 6 is a flow chart diagram illustrating the operations to create a remote volume and remote snapshot for an embodiment of the present invention;

FIG. 7 is a flow chart diagram illustrating the operations to copy a primary snapshot to a remote snapshot for an embodiment of the present invention;

FIG. 8 is a flow chart diagram illustrating the operations performed when failing over to a remote volume after a failure in a primary volume for an embodiment of the present invention;

FIG. 9 is a flow chart diagram of operations performed to generate a split mirror for an embodiment of the present invention;

FIG. 10 is a flow chart diagram of operations to failback (resynchronize) for an embodiment of the present invention;

FIG. 11 is a block diagram of layer-equivalence and comparison when resynchronizing for an embodiment of the present invention; and

FIG. 12 is a flow chart diagram for operations to generate an initial copy of a volume for an embodiment of the present invention.

### DETAILED DESCRIPTION

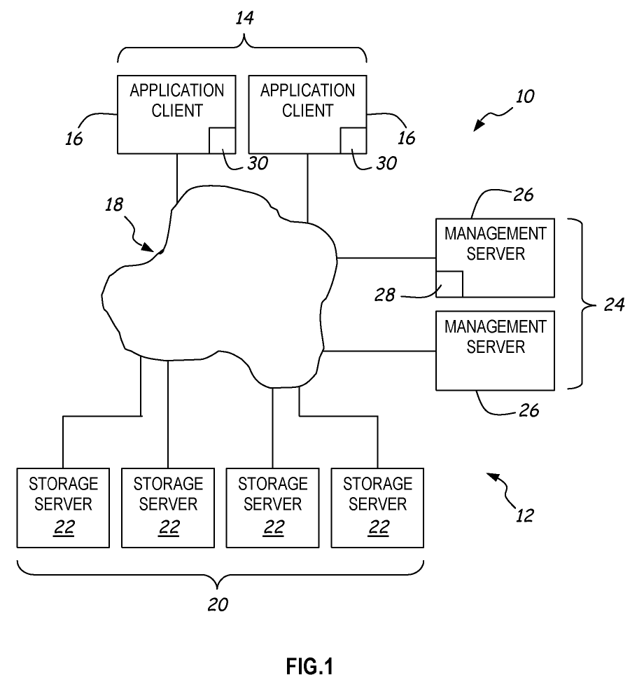

Referring to FIG. 1, a block diagram illustration of a network system of an embodiment of the present invention is described. In this embodiment, a networked computer system 10 includes a distributed storage system 12, hereinafter system 12. The networked computer system 10 comprises: (a) an application client system 14 that comprises one or more application clients 16 (i.e., a computer that is or will run an application program); (b) the system 12; and (c) a network 18 for conveying communications between the application clients 16 and the system 12, and between elements of the system 12. In the illustrated embodiment, the network 18 is a Gigabit Ethernet network and data is transferred between network components using a packet switched protocol such as Internet protocol. However, the invention is applicable or adaptable to other types of networks and/or protocols, including fibre channel, ethernet, Infiniband, and FDDI, to name a few.

With continuing reference to FIG. 1, the system 12 is comprised of a storage system 20 that provides data storage capability to an application program executing on an application client. The storage system 20 comprises one or more storage servers 22. Each storage server 22 comprises at least one data storage device and at least one interface for communicating with the network 18. In one embodiment, the data storage device is a disk drive or a collection of disk drives. However, other types of data storage devices are feasible, such as, for example, tape drives or solid state memory devices. Typically, when the storage server 22 is comprised of multiple data storage devices, the devices are all of the same type, such as disk drives. It is, however, feasible to use different types of data storage devices, such as disk drives and tape drives, different types of disk drives, different types of tape drives, or combinations thereof.

With continuing reference to FIG. 1, the system 12 is further comprised of a management storage server system 24 that provides management functions relating to data transfers between the application clients and the storage system 20, and between different elements within the storage system 20. The management storage server system 24 of this embodiment comprises one or more management storage servers 26. Generally, it is desirable to have multiple management storage servers 26 for fault tolerance. Each management storage server 26 comprises at least one interface for communicating with the network 18 and at least one data storage device, such as a disk drive or tape drive. In addition, at least one of the management storage servers 26 comprises an interface 28 that allows a user to interact with the server 26 to implement certain functionality relating to data transfers between an application client 16 and the storage system 20. In one embodiment, the interface 28 is a graphical user interface (GUI) that allows a user to interact with the server 26 via a conventional monitor and keyboard or mouse. Other types of interfaces that communicate with other types of peripherals, such as printers, light pens, voice recognition, etc., or network protocols are feasible. It should also be appreciated that a management storage server 26 may be co-located with a storage server 22, and a management server 26 may also be a distributed server that is distributed across several storage servers 22.

With continuing reference to FIG. 1, the system 12 further comprises a driver 30 that is associated each application client 16 and facilitates communications between the application client 16 and the system 12. It should be appreciated that there are alternatives to the use of driver 30. For example, a Peripheral Component Interconnect (PCI) card or Host Bus Adapter (HBA) card can be utilized.

Each of the management storage servers 26, in an embodiment, comprises a data storage configuration identifier that relates to a storage configuration map that reflects composition of the storage system 20 and the allocation of data storage across the storage system 20 to the various application clients 16 at a point in time. The data storage configuration identifier has a value that changes when the composition of the storage system 20 changes or the allocation of storage within the system 20 changes. In one embodiment, the storage system uses a configuration identifier as described in U.S. Pat. No. 6,732,171 B2 entitled “Distributed Network Storage System With Virtualization,” assigned to the assignee of the present invention, and is incorporated herein by reference in its entirety. In this embodiment, the storage configuration map identifies each of the storage servers 22 in the storage system 20. In addition, the map identifies each logical or virtual volume, i.e., an amount of data storage that is distributed between two of more the storage servers 22 that is allocated to a particular application client 16. Further, the map identifies the partitioning of each logical or virtual volume, i.e., how much data storage of the volume is provided by each of the storage servers 22. In one embodiment, data is transferred between the components of the network system as blocks of data, each block having a preset size and an address that corresponds to a physical storage location within a storage server 22. In another embodiment, data is transferred as files, and each file may comprise a number of blocks of data.

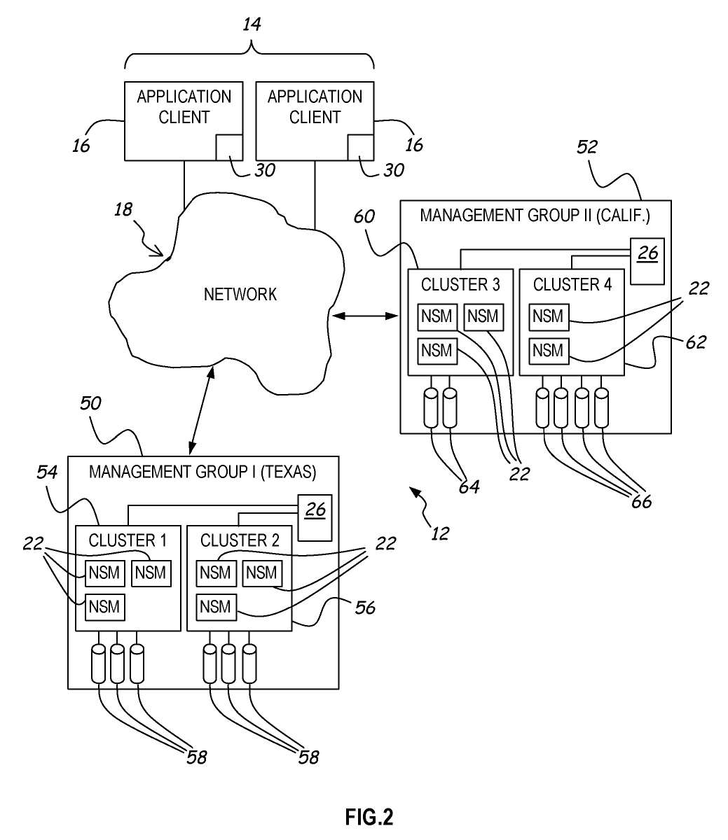

Referring now to FIG. 2, a block diagram illustration of a storage configuration of one embodiment of the present invention is now described. In this embodiment, the data storage network 12 is comprised of two separate management groups 50, 52. In this embodiment, the first management group 50 is located in Texas, and the second management group 52 is located in California. The locations of Texas and California are described for the purposes of illustration only. As will be understood, the management groups 50, 52 may be located at any geographic location, including locations within the same building, between buildings on a campus, between cities, states and/or countries. Each management group 50, 52 comprises a management data storage server 26 and one or more data storage servers 22. In the embodiment of FIG. 2, the first management group 50 contains six data storage servers, and the second management group 52 contains five data storage servers. The data storage servers 22, in one embodiment, comprise network storage modules (NSMs) that comprise a network connection and a plurality of hard disk drives.

Referring still to FIG. 2, each management group has one or more clusters of data storage servers 22, with each cluster having one or more logical volumes stored across the data storage servers 22 within the cluster. In the embodiment of FIG. 2, the first management group 50 contains a first cluster 54 and a second cluster 56 each cluster 54, 56 having three NSMs 22 and configured to have three virtual volumes 58. Each volume 58 is configured by the management storage server, and portions of each volume may be stored on one or more NSMs 22 within the cluster 54, 56, thus making the volume a distributed volume. Similarly, the second management group 52 contains a third cluster 60 and a fourth cluster 62. Third cluster 60 has three NSMs 22 and is configured to have two virtual volumes 64, while the fourth cluster 62 has two NSMs 22 and is configured to have four virtual volumes 66. Each of the volumes 64, 66 is configured by the management storage server, and portions of each volume may be stored on one or more NSM 22 within the cluster 60, 62, thus making the volume a distributed volume.

An application client 16 running a first application program may read data from and write data to, for example, a volume 58 within the first cluster 54. An application client 16 running a second application program may read data from and write data to, for example, a volume 64 within the third cluster. As will be described in more detail below, data stored within a volume 58 of the first cluster may be copied to any other volume within the system in order to provide backup or redundant data storage that may be used in the event of a failure of the volume storing the data. Data may also be copied between volumes for other purposes than providing backup, such as, for example, data migration or drive image cloning. As will be understood, the embodiment of FIG. 2 is merely one example of numerous configurations a data storage system may have. For example, while management groups 50, 52 are illustrated having associated clusters, clusters may exist independently of management groups. In another embodiment volumes may be replicated across different storage clusters. These replicated volumes may be synchronous replicas, providing a synchronous replica of the data stored at the volume. When data is modified by a host application, the data is written to all of the volumes that are synchronous replicas.

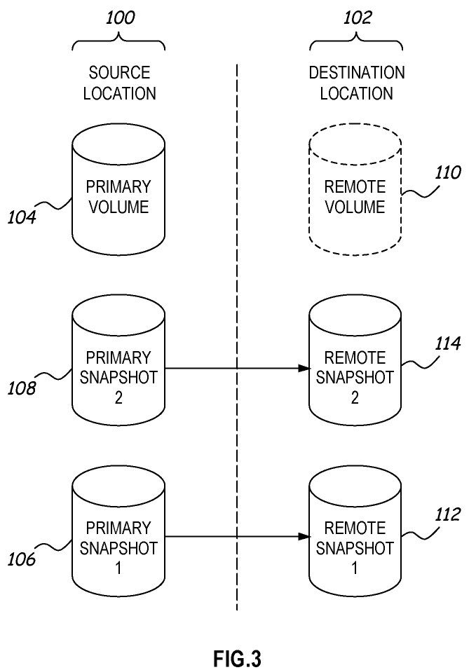

Referring now to FIG. 3, a block diagram illustration of a primary and remote volume for an embodiment of the present invention is now described. In this embodiment, source location 100 and a destination location 102 each contain one or more volumes of data storage. In this embodiment, source location 100 contains a primary volume 104, a first primary snapshot 106, and a second primary snapshot 108. The destination location 102 contains a remote volume 110, a first remote snapshot 112, and a second remote snapshot 114. In an embodiment, the primary volume 104 comprises a plurality of pages of data. A page of data, as referred to herein, is a logical block of data that comprises a plurality of physical blocks of data. The physical blocks of data each have a unique physical address associated with a data storage device and data to be stored at said unique physical address. For example, as is well known in the art, a hard disk drive stores data on a physical media and has a predefined block addressing system for the location on the physical media at which a block of data is stored. The hard disk drive uses this addressing system to position a read/write head at the location on the physical media at which the block data is stored.

The primary volume also has identification information that includes information related to the volume such as a volume name and a size quota. The size quota of a volume is the maximum amount of storage that the volume is permitted to consume. The primary volume 104 contains data and provides data storage for one or more application clients. As data is read from and written to the primary volume 104, the data within the primary volume 104 changes. In this embodiment, changes to the primary volume 104 are recorded using snapshots. A snapshot, as referred to herein, is a point in time view of data stored within a volume of data. In the embodiment of FIG. 3, the primary volume 104 has two associated snapshot copies. The first primary snapshot 106 contains data from the primary volume 104 as it stood at the time the first primary snapshot 106 was generated. The first primary snapshot 106 also includes information such as a name for the snapshot, the time the snapshot was created, and a size of the snapshot. The second primary snapshot 108 contains data from the primary volume 106 that changed during the period between the time the first primary snapshot was generated and the time the second primary snapshot was generated. Similarly as described with respect to the first primary snapshot 106, the second primary snapshot 108 also includes information such as a name for the snapshot, the time the snapshot was created, and a size of the snapshot. The format of the snapshot copies and the determination of data contained within the snapshot copies, for one embodiment, will be described in more detail below.

Still referring to FIG. 3, the remote volume 110 does not contain data, but contains a pointer to the remote snapshots 112, 114. The remote volume 110, similarly as described with respect to the primary volume, also includes information related to the volume such as a volume name and a size quota. In one embodiment, the size quota for a remote volume is set to zero because the remote volume 110 does not contain any data, and data may not be written to the remote volume 110. In one embodiment, however, data may be read from the remote volume by an application client. The first remote snapshot 112 contains a copy of the data from the first primary snapshot 106, and the second remote snapshot 114 contains data from the second primary snapshot 108. In this manner, the destination location 102 contains a copy of the data from the primary volume 104 as of the time that the second primary snapshot 108 was generated. In the event of a failure of the primary volume 104, the data from the first remote snapshot 112 and second remote snapshot 114 may be combined to provide a view of the primary volume as of the time of the second primary snapshot 108. This data may then be used for read and write operations that normally would have been performed on the primary volume 104, and only the data changed since the time of the second primary snapshot 108 is not represented in the copy of the primary volume 104.

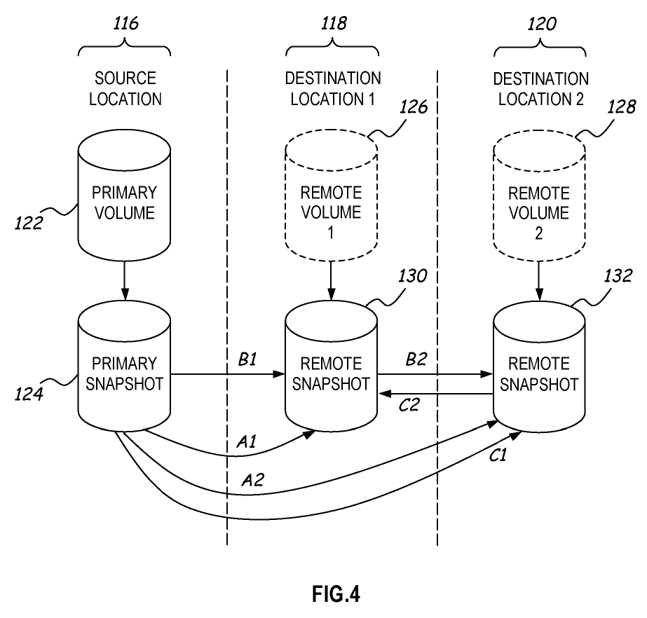

Referring now to FIG. 4, a block diagram illustration of a single source location 100, and a first destination location 102 and second destination location 116 is described. In this embodiment, the source location 116 contains a primary volume 122 and a primary snapshot 124. The first destination location contains a first remote volume 126, and the second destination location 120 contains a second remote volume 128. Each of the first and second remote volumes 126, 128, has an associated first and second remote snapshot 130, 132, respectively. When copying data from the source location 116 to the destination locations 118, 122, the data may be copied in a similar manner as described with respect to FIG. 3. Similarly as described with respect to FIG. 3, each of the remote volumes 126, 128 in the destination locations 118, 120, contain a pointer to their respective remote snapshots 130, 132. A primary snapshot 124 of the data in the primary volume 122 is generated. Following the generation of the primary snapshot 124, the data from the primary snapshot 124 is copied to the destination locations 118, 120 according to one of several options. The data may be copied in parallel from the source location 100 to both remote snapshots 130, 132, as indicated by arrows Al and A2. In this manner, the data is fanned out from the source location 116 to each destination location 118, 120. Alternatively, the data from the source location 100 may be copied to remote snapshot 130 at the first destination location 118, as indicated by arrow B1, and the data from remote snapshot 130 is then copied to remote snapshot 132 at the second destination location 120, as indicated by arrow B2.

Similarly, the data from the source location 100 may be copied to remote snapshot 132 at the second destination location 120, as indicated by arrow C1, and the data from the remote snapshot 132 is then copied to remote snapshot 130 at the first destination location 118, as indicated by arrow C2. In this manner, the data is cascaded, or chained, from one destination location to the next destination location. Whether data is fanned out or cascaded to multiple destination locations can be selected in one embodiment. Furthermore, the order in which data is cascaded between two destination locations may also be selected. These selections may be based upon one or more of the link bandwidth between the various locations, the speed at which the snapshot data may be copied at each destination, the latency of the links to each destination and between destinations, the likelihood that a location will be available, the least loaded source, and the source having the least expensive network connection, among other factors. In one embodiment, the source location 116 and first destination location 118 are located within a data center for an enterprise, and the second destination location 120 is a long term backup facility that, in an embodiment, stores data on a tape backup system. In this embodiment, the tape backup is copied from the remote snapshot at the first destination location 118 in order to provide enhanced performance at the primary volume during the tape backup such as by, for example, removing backup window limitations associated with backing up data to tape from the primary volume.

Furthermore, each of the first and second destination locations may also have primary volumes and primary snapshots that may be copied to one or both of the other locations. Copies may be performed in the same manner as described above, resulting in each location having both primary volumes and primary snapshots, as well as remote volumes and remote snapshots. In one embodiment, each of the locations contains a data center for an enterprise. The data stored at each data center is copied to other data centers in order to provide a redundant copy of the data in each data center.

As discussed above, a primary volume may have one or more synchronous replicas. The primary replication level may be changed without disrupting the process for generating a remote copy of the snapshot. Furthermore, when generating a remote snapshot, the system may copy data from the replica that is most efficient to copy from. For example, the copy may be made from the source that is most available, least loaded, has the fastest link, and/or has the cheapest link. Similarly, the remote volume may also be configured to have synchronous replicas. Similarly as described with respect to primary replication levels, remote replication levels may be modified without having any impact on the copy process.

In another embodiment, some or all of the primary volumes from within a cluster may be grouped. A snapshot schedule may be set for the entire group of primary volumes, thus setting a snapshot schedule for the primary volumes included in the group. Remote snapshots may also be scheduled for a group of primary volumes. If a primary volume group has snapshots generated, the snapshots may be copied to associated remote volumes as a group.

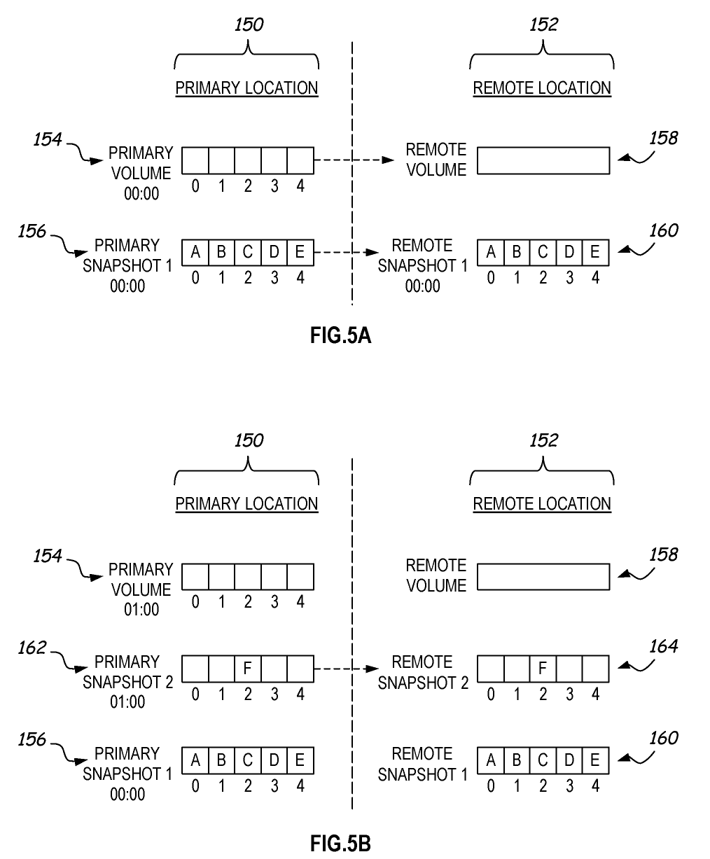

Referring now to FIGS. 5A and 5B, a block diagram illustration of data contained in volumes and snapshots is now described. In this embodiment, data is copied from a primary location 150 to a remote location 152. Data is stored in a primary volume 154 as a plurality of pages of data, and the primary volume 154 contains pointers to the pages of data. As illustrated in FIG. 5A, primary volume 154 contains five pages of data 0-4, each page containing data A-E, respectively. A first primary snapshot 156 is generated from the primary volume 154. In this example, the time of the first primary snapshot 156 is 00:00, and the snapshot thus records the state of the primary volume 154 at time 00:00. The first primary snapshot 156 contains 5 pages of data (0-4), each containing the data (A-E) associated with the respective page of data from the primary volume 154. The first primary snapshot 156 is generated by establishing a new layer for data storage as the primary volume 154. The new layer for data storage contains pointers to the pages of data contained in the first primary snapshot 156. Accordingly, following the generation of the first primary snapshot 156, the primary volume 154 simply contains pointers that reference the data stored in the pages associated with the first primary snapshot. Upon receiving a write request from the driver 29 associated with a client application a new page of data is written and the pointer associated with that page of data in the primary volume 154 is modified to reference the new page of data. Because the original page of data has not been modified, the first primary snapshot 156 continues to contain the original page of data. Consequently, the data in the pages of the first primary snapshot 156 are preserved. Upon receiving a read request for any page of data that has not been modified since the first primary snapshot was generated, the data from the associated page of data in the layer of the first primary snapshot is read and supplied to the entity initiating the read request. If the read request is for a page of data that has been modified since the first primary snapshot, the data is read from the page of data associated with the layer of the primary volume. The remote location 152 contains a remote volume 158 that, as described previously, contains a pointer to a first remote snapshot 160. The data from the first primary snapshot 156 is copied from the primary snapshot 156 to the first remote snapshot 160. Thus, the first remote snapshot 160 contains 5 pages of data (0-4), each containing the data (A-E) associated with the respective page of data from the first primary snapshot 156 and from the primary volume 154 as of time 00:00.

Referring now to FIG. 5B, following the creation of the first primary snapshot 156, and the copying of the first primary snapshot 156 from the primary location 150 to the remote location 152, a second primary snapshot 162 is generated. The second snapshot copy 162, in this example, is generated from the primary volume 154 at the time 01:00. Accordingly, the second primary snapshot 162 contains pages of data from the primary volume 154 that have been modified after 00:00 and up to 01:00. In the example of FIG. 5B, one page of the primary volume 154 has been modified during this time period, namely page 2 has been modified from ‘C.’ to ‘F.’ When generating the second primary snapshot 162, a new layer is generated for the primary volume 154, and any data written to the primary volume is written to a new page of data that is associated with the new layer. In the example of FIG. 5B, the data contained in page 2 is the primary volume 154 has been modified relative to the first primary snapshot 156. Accordingly, the second primary snapshot 162 contains one page of data. The second primary snapshot 162 is copied to the remote location 152 to create a second remote snapshot 164. The second remote snapshot 164 also contains one page of data, thus representing the changes in the primary volume 154 since the time of the first remote snapshot 154.

With continuing reference to FIGS. 5A and 5B, several properties of such a system are described. As can be seen from the FIGS. 5A and 5B, following the initial snapshot copy 156, the second snapshot copy 162 contains only pages from the primary volume 154 that have been modified since the first primary snapshot 156. In this manner, so long as at least one snapshot copy of the primary volume 154 is present, later snapshot copies contain only pages modified on the primary volume 154 since the previous snapshot. When copying snapshot copies to the remote location 152 from the primary location 150, the incremental snapshots require only copying of the pages modified since the previous snapshot copy. In the example of FIG. 5, when copying the second primary snapshot 162 to the second remote snapshot 164, only one page of data is required to be copied between the primary location 150 and the remote location 152.

In this embodiment, when a snapshot copy is deleted, the pages from the deleted snapshot are merged into any subsequent snapshot copy of the volume. If the subsequent snapshot copy contains pages of data that have been modified since the generation of the deleted snapshot, the subsequent snapshot continues to reference these pages of data, and the remaining pages of data associated with the deleted snapshot are referenced by the subsequent snapshot. Thus, the remaining subsequent snapshot contains a view of the data in the volume at the point in time the subsequent snapshot was generated. In the example of FIG. 5, if the first primary snapshot 156 were deleted, the second snapshot would be modified to reference the four pages of data not included in the second primary snapshot 162, while the pointer to the one page of data originally contained in the second snapshot would remain unchanged. The second primary snapshot 162 would then contain five pages of data. Thus, if a third primary snapshot were subsequently made, only incremental changes in the primary volume 154 would be copied to the third primary snapshot. Similarly, if both the first primary snapshot 156 and second primary snapshot 162 were deleted, and a third primary snapshot were subsequently made, all of the pages from the primary volume 154 would be included in the third snapshot.

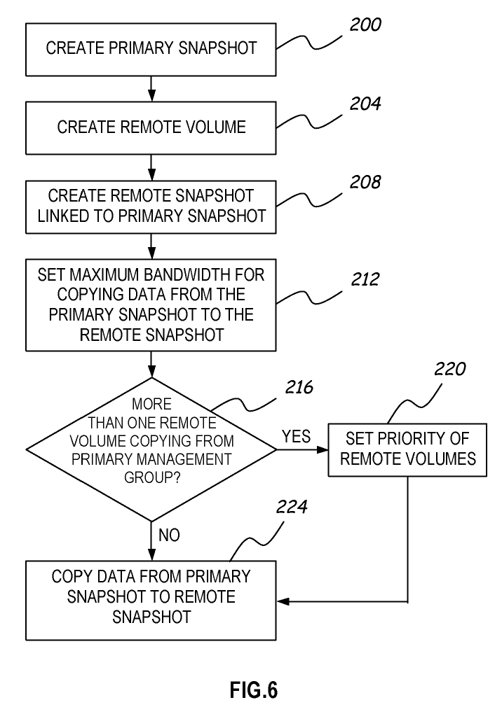

Referring now to FIG. 6, the operational steps for creating a remote volume and remote snapshots linked to a primary volume are described for an embodiment of the present invention. Initially, at block 200, a primary snapshot is created from a primary volume. As discussed previously, a primary snapshot is generated from a primary volume, and includes all of the data from the primary volume when it is the only primary snapshot, and contains incremental modified pages of data from the primary volume when a previous snapshot is present. In one embodiment, a primary snapshot is created by a user through the user interface in a management storage server associated with the management group containing the primary volume. In this embodiment, a user may also set a snapshot schedule, defining intervals at which snapshot copies of the primary volume are to be generated, and defining how long to keep snapshot copies before deletion.

With continuing reference to FIG. 6, a remote volume is created according to block 204. The remote volume, in one embodiment, is created in a second management group through a second management storage server. The remote volume is created within a cluster and is located at a location that is remote from the primary volume. Alternatively, the remote volume may be created within the same management group, and even within the same cluster, as the primary volume. As previously discussed, the remote volume does not contain data, but rather contains a pointer to a remote snapshot. The remote volume is thus not able to be written to by a client application. However, in an embodiment, data may be read from remote snapshots. At block 208, a remote snapshot is created and linked to the primary snapshot. In one embodiment, the user, when linking the remote snapshot to the primary snapshot, also links the snapshot schedule with the primary volume snapshot schedule, thus resulting in the remote volume copying each scheduled primary snapshot. Alternatively, the remote snapshot may be made individually without a schedule, or according to a separate schedule for remote snapshots that may be made, and that is independent of the schedule for generating primary snapshots.

At block 212, a maximum bandwidth is set for copying data from the primary snapshot to the remote snapshot. The maximum bandwidth sets a limit on the amount of bandwidth that may be used when copying data from the primary snapshot to the remote snapshot. For example, if the storage servers containing the primary and remote volumes are connected with a 256 kB/sec network link, the maximum theoretical bandwidth that may be used in copy operations is 256 kB/sec. However, in order to maintain adequate network bandwidth for other applications and devices using the network, the maximum bandwidth for copy operations may be limited. For example, a maximum bandwidth for copying data from the primary snapshot to the remote snapshot may be set at 128 kB/sec, thus limiting the amount of bandwidth to 50 per cent of the network link for copying snapshots. Setting a maximum bandwidth may be desirable in certain circumstances in order to maintain a set amount of bandwidth for read and write operations to the management group and storage servers containing the remote volume. In another embodiment, the maximum bandwidth setting is able to be scheduled, providing additional bandwidth for copying snapshots during periods where network usage for read and write operations is reduced, such as during evening and night hours. The maximum bandwidth may also be dynamically set according to network usage at a particular point in time.

Referring still to FIG. 6, following the setting of the maximum bandwidth, it is determined at block 216 whether more than one remote volume exists that is copying from the primary management group. If more than one remote volume exists, a priority of remote volumes is set at block 220. Following the setting of volume priority, or if more than one remote volume is not present at block 216, data is copied from the primary snapshot to the remote snapshot, according to block 224. When setting priority of remote volumes, remote volumes associated with critical primary volumes may be set at a higher priority, resulting in data from the higher priority primary volume being copied ahead of data from lower priority volume(s). For example, if two primary volumes have associated remote volumes located at a remote management group, and one of the primary volumes contains critical financial data while the other primary volume contains non-critical biographical data, the remote volume associated with the primary volume having the financial data may be set to a higher priority. In this manner, the financial data is backed up to the remote volume with higher priority, thus if the primary volume fails, it is more likely that the primary volume is backed up to the remote volume.

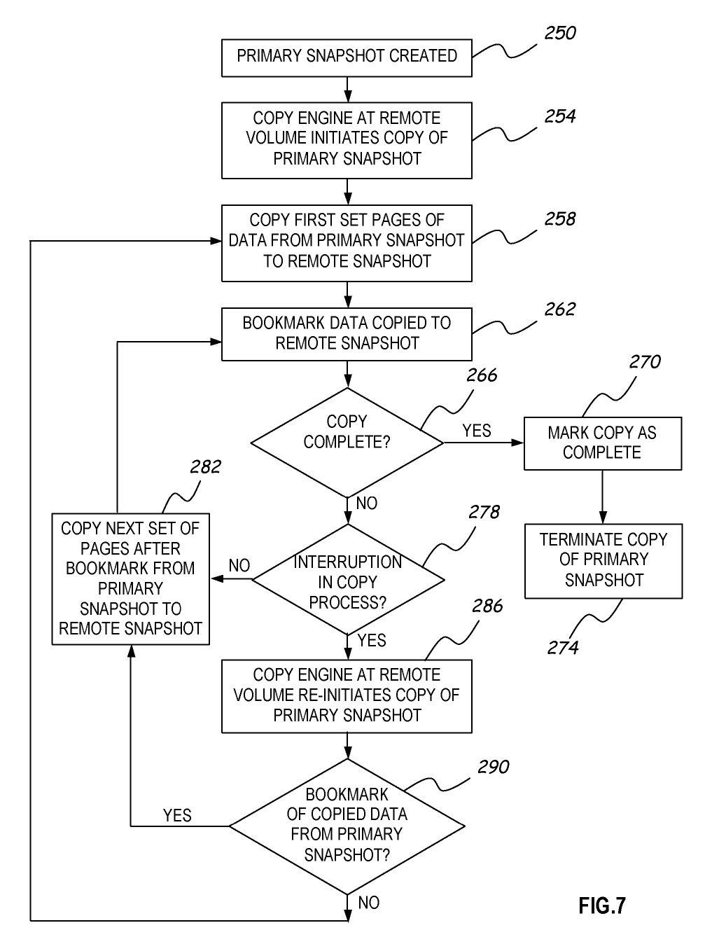

Referring now to FIG. 7, the operational steps for copying data from a primary snapshot to a remote snapshot are described. Initially, at block 250, the primary snapshot is created. The management server associated with the cluster containing the remote volume initiates a copy engine at the remote volume. This copy engine controls the copying of data from the primary snapshot. At block 254, the copy engine at the remote volume initiates a copy of the primary snapshot. At block 258 the copy engine at the remote volume copies a first set of pages of data from the primary snapshot to the remote snapshot. The copy engine sets a bookmark indicating that the first set of data has been copied to the remote snapshot, as noted at block 262. Bookmarking allows the copy engine to resume copying at the point of the bookmark in the event of a failure or an interruption in the copying of the remote snapshot. The number of pages in the first set of pages may be set as a percentage of the data to be copied, such as 10 percent, or may be a set number of pages. The number of pages in the first set of pages, in one embodiment, is adaptive based on the amount of data to be copied or the rate at which it is copied. If the amount of data to be copied is a relatively large amount of data, bookmarks may be set at every 10 percent, where if the amount of data to copy is relatively small, bookmarks may be set at 50 percent. Similarly, if the rate at which data is copied is relatively fast or slow, bookmarks may be set at higher or lower percentages. Furthermore, if the amount of data to be copied is below a certain threshold or if the rate at which the data is being copied is sufficiently fast, no bookmarks may be set, as the overhead used in setting any bookmarks makes setting such a bookmark inefficient. The monitoring of the data transferred, and the bookmarking of the data allows a management server to monitor the status of a copy being made and display the status on a graphical user interface.

Referring again to FIG. 7, at block 266, it is determined if the copy is complete. If the copy is complete, the remote snapshot copy is marked as complete at block 270, and the copy operation is terminated at block 274. If, at block 266, it is determined that the copy is not complete, it is determined at block 278 if the copy process had been interrupted. The copy process may be interrupted, for example, if a failure occurs at either the primary volume, at the remote volume, or if there is a failure in the network link between the primary and remote volumes. The copy process may also be interrupted if the configuration of either of the management groups containing the primary and remote volumes is modified. If the copy process has not been interrupted, the copy engine copies the next set of pages after the bookmark from the primary snapshot to the remote snapshot as indicated at block 282, and the operations of block 262 are repeated. If the copy process has been interrupted, the copy engine at the remote volume re-initiates the copy of the primary snapshot according to block 286. At block 290, it is determined if a bookmark of the copied data from the primary snapshot exists. If a bookmark exists, the operations of block 282 are repeated. If a bookmark does not exist, the operations described with respect to block 258 are repeated.

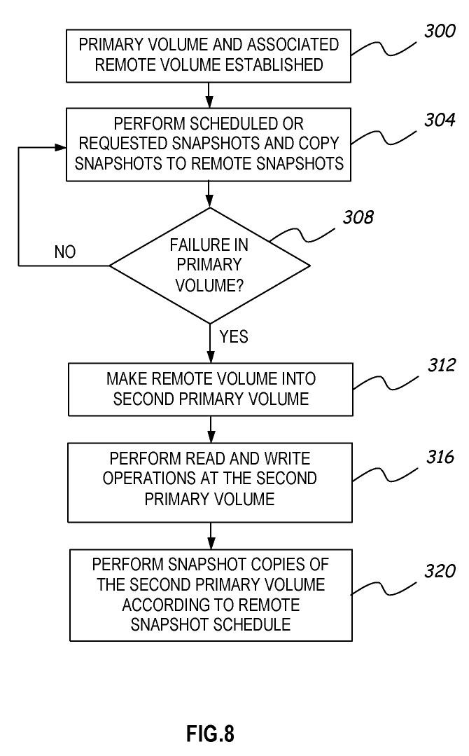

Referring now to FIG. 8, the operations associated with a failure of the primary volume are described. Initially, as indicated at block 300, the primary volume and associated remote volume are established, as previously described. At block 304, scheduled or requested snapshots are performed and the primary snapshots are copied to remote snapshots. At block 308, it is determined if there has been a failure in the primary volume. If there is not a failure in the primary volume, the operations of block 304 are repeated. If it is determined that there is a failure in the primary volume, the remote volume is made into a second primary volume, as indicated at block 312. The remote volume is made into a primary volume, in an embodiment, by re-defining the remote volume to be a primary volume. When re-defining the remote volume as the second primary volume, the second primary volume is set to contain pointers to the most recent page of data available for a particular page of data from the remote snapshots. The second primary volume is set as a new layer, leaving the data of the remote snapshots intact, and a size quota for the second primary volume is set to be non-zero and, in an embodiment, is set to the corresponding size quota of the first primary volume. For example, if two remote snapshots are present at the remote volume, the copy engine goes through the snapshots page by page, and if a page is present in the later snapshot the pointer for that page of the second primary volume is set to the page of the later snapshot. If a page is not present in the later snapshot, the pointer for that particular page in the second remote volume is set to the page from the earlier snapshot. After the second primary volume has been defined, read and write operations are performed using the second primary volume, according to block 316. At block 320, snapshot copies of the second primary volume are generated according to the remote snapshot schedule. Any new snapshot copies generated from the second primary volume are separate from the remote snapshot copies. In this manner, the second primary volume may have snapshot copies generated in the same manner as the primary volume, while maintaining copies of the primary volume as of the time of the latest snapshot copied from the primary volume.

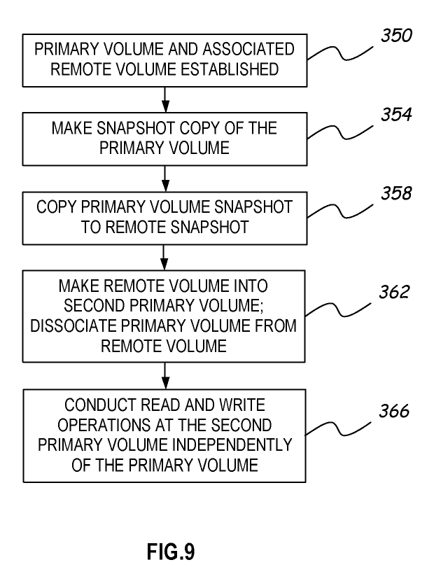

Referring now to FIG. 9, the operational steps for creating a split mirror are described. A split mirror may be used for data migration, data mining, or other purposes where a first primary volume is copied to a second primary volume, and the second primary volume is used independently of the first primary volume. For example, in a data mining application, a second primary volume may be created and used for data mining, thus leaving the first primary volume available for read and write operations without performance degradation related to the data mining operations. Once the data mining operations are complete on the second primary volume, it may be made into a remote volume and used to store remote snapshots, or it may be deleted. Alternatively, a split mirror may also be used to recover data that was stored at the primary volume, but that was inadvertently deleted or overwritten by other data. For example, a user of a host application may create a user data file and store that user data at a primary volume. A snapshot copy of the primary volume is generated, including the user data, and the snapshot is copied to a remote snapshot. The primary snapshot is later deleted by a system administrator or by a schedule. The user then inadvertently deletes the user data, or overwrites the user data with data that is not useful to the user. This deletion or overwrite is stored at the primary volume, and the previous data is not accessible by the user. At the request of the user, a system administrator may create a second primary volume from the remote snapshots, roll the second primary volume back to the point where the user data is present, and recover the user data, while leaving the primary volume available for read and write operations.

Referring again to FIG. 9, at block 350, the primary volume and associated remote volume are established. At block 354, a snapshot copy is made of the primary volume. The primary volume snapshot is copied to a remote snapshot, as illustrated at block 358. The remote volume is made into a second primary volume, and the primary volume is dissociated from the remote volume, as indicated at block 362. At block 366, read and write operations are conducted at the second primary volume independently of the first primary volume.

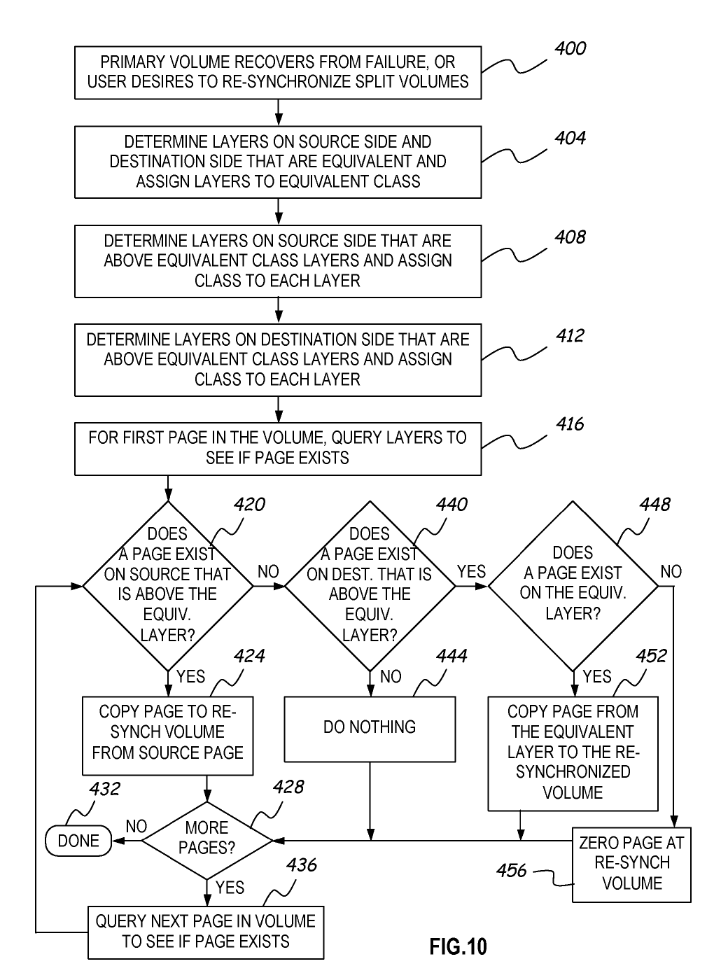

Referring now to FIG. 10, re-synchronization of a primary volume and a second primary volume is now described. In this embodiment, the primary volume may have failed, or otherwise been split from a second primary volume, and it is desired to combine the volumes together again. In this embodiment, at block 400, the primary volume recovers from the failure, or the user desires to re-synchronize split volumes. At block 404, it is determined what layers associated with each volume are equivalent, and assign the equivalent layers to an equivalence class. Layers are equivalent if they are identical at both volumes. Such layers include primary snapshots that were copied to remote snapshots, and the primary and remote snapshots are still present at each volume. Because the data in each if the copies is identical, the layers are defined as being equivalent and assigned to the equivalence class. At block 408, it is determined if the source side includes any layers that are above the equivalence class, and each such layer is assigned a class. At block 412 it is determined if the destination side includes any layers that are above the equivalence class, and each such layer is assigned a class. Following the assignment of the various layers at both the source and destination, the various layers are queried to see if the first page in the volume is present in any of the layers, as indicated at block 416.

At block 420, it is determined if a page exists on the source side that is above the equivalence layer. If there is a page on the source side above the equivalence layer, the page is copied to the destination volume from the source layer containing the page, as indicated at block 424. At block 428, it is determined if any more pages are present in the volume. If there are no more pages on the volume, the re-synchronization is done, as noted at block 432. If there are more pages on the volume, the next page in the volume is queried to determine if the page exists on any of the layers, as indicated at block 436. The operations described with respect to block 420 are then repeated for the next page. If, at block 420, it is determined that the source does not contain the first page in a layer above the equivalence layer, it is determined if the page exists at the destination that is above the equivalence layer, as indicated at block 440. If the page is not present at any layer above the equivalence layer at the destination, no page is written or copied to the re-synchronized volume, as noted at block 444. The operations described with respect to block 428 are then repeated. If the determination at block 440 indicates that a page exists at the destination on a layer above the equivalence layer, it is determined at block 448 if the page exists on an equivalence layer. If the page does exist on a page in the equivalence layer class, the page is copied from the equivalence layer to the re-synchronized volume, as indicated at block 452. The operations associated with block 428 are then repeated. If it is determined at block 448 that a page does not exist on an equivalence layer, the page is written as zeros on the re-synchronized volume, at noted at block 456. The operations associated with block 428 are then repeated.

In this manner, a re-synchronized volume is created that includes changes from the source volume after the destination volume has been modified. A system administrator or other user may then use the re-synchronized volume, along with the latest copy of the destination volume, to reconcile any differences between the re-synchronized volume and destination volume. The re-synchronized volume may be copied to the source location and used as a new primary volume. The operations associated with the re-synchronization, in an embodiment, are performed by the copy engine associated with the destination location. In one embodiment, the copy engine, when copying pages to the re-synchronized volume, selects the source for the copy to be the source having the most efficient copy speed. For example, if a page to be copied is located in a layer in the equivalence class, the copy engine selects the source for copying the page of data to be a page from the destination location. Similarly, if the source contains a layer that is to be copied to the re-synchronization volume, and a copy of the page also exists on a replicated volume having a higher link speed to the destination location, the copy engine selects the source for the copy to be the replicated volume.

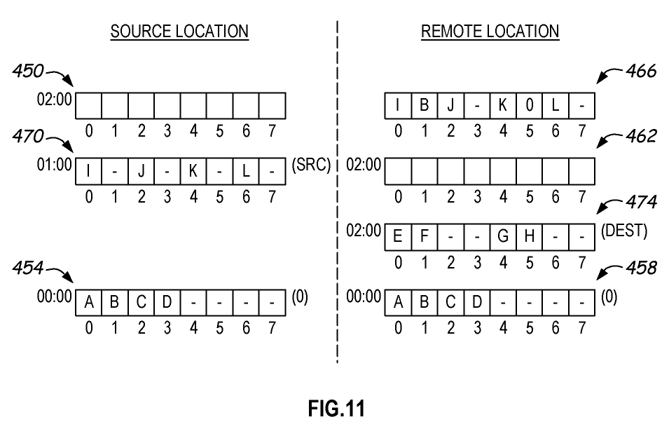

Referring to FIG. 11, a block diagram illustration of re-synchronization for an embodiment of the invention is now described. In this embodiment, the source location includes a source volume 450 and a source snapshot 454. The source snapshot 454 was generated at 00:00, and has data in the first four pages corresponding to the state of the source volume 450 as of 00:00. The source snapshot 454 is also present at the destination location as a remote copy 458 that corresponds to the source snapshot. Following the creation of the source snapshot 454, the source volume 450 performs read and write operations modifying data in four of the pages within the source volume 450, the four pages in this example being pages 0, 2, 4, and 6. The source volume 450 has a failure at 01:00, and no further snapshots have been made. Following the failure of the source volume 450 of this example, the remote volume associated with the remote snapshot 458 is turned into a second primary volume 462 and data from the remote snapshot 458 is copied into the primary the remote snapshot 458 is copied into the second primary volume 462. The second primary volume 462 then performs read and write operations, resulting in four pages being modified in the second primary volume 462. In this example, pages 0, 1, 4, and 5 are modified. At 02:00, the source volume recovers from the failure, and the volumes are re-synchronized. In this case, the source volume 450 contains data written to the volume from 00:00 to 01:00. Following failure of the remote volume 450, the second primary volume 462 contains data written to the volume from 01:00 to 02:00. After the source volume 450 recovers from the failure, it is desired to re-synchronize the volumes, and the operations described with respect to FIG. 10 are performed. In this example, a re-synchronization volume 466 is created, and the layers of data at the source and destination location are placed into the appropriate classes. In this example, the source snapshot 454 and the remote snapshot 458 are equivalent, and thus placed in an equivalence class, illustrated as class (0). In order to determine pages within each volume that have been modified, a snapshot is generated for each volume. For the source volume, a second source snapshot 470 is generated that includes pages of data that have been modified since the source snapshot 454. Similarly, a second primary volume snapshot 474 is generated that includes pages of data that have been modified after the second primary volume 462 was created. The second source snapshot 470 is designated as the source class, illustrated as class (SRC). The second primary volume snapshot 474 is designated as the destination class, illustrated as class (DEST). Each page of the volume is then queried according to the operations of FIG. 10, to generate the re-synchronized volume 466.

While the re-synchronization of the source and destination location is described in terms of layers of data for each location, it will be understood that other techniques may be used to determine data that has been modified at each location, and then comparing the differences in data for each location to generate the re-synchronized volume. Furthermore, the roles of the source location and destination location may be reversed, with the re-synchronized volume generated at the source location. In this case, the re-synchronized volume would contain data modified at the second primary volume 462 following the failure of the source volume 450.

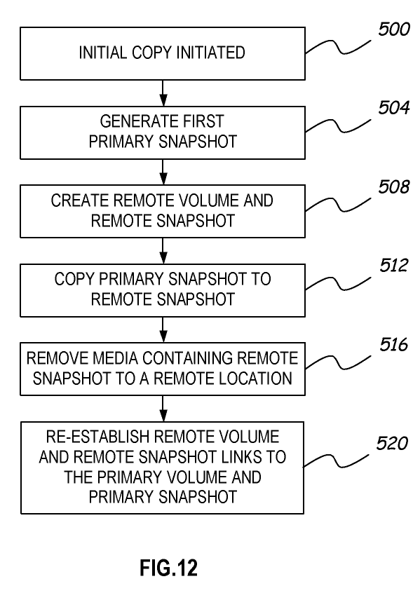

Referring now to FIG. 12, the operational steps for generating an initial remote snapshot copy for a volume containing a large amount of data are described for an embodiment of the invention. In this embodiment, a source volume is present that contains a large amount of data. The source volume may contain data from a legacy system that has recently been migrated to a source storage volume of the present invention. In such a case, the source storage volume may contain, for example, a terabyte of data. Copying the initial snapshot copy of this source storage volume may take a significant amount of time, particularly if the source and remote storage locations are connected by a relatively low bandwidth data link. Furthermore, even in the event that the systems are connected by a relatively high bandwidth, it may be desirable to reduce the network resources associated with generating the initial remote snapshot. In the embodiment of FIG. 12, an initial copy of the source volume is initiated, as indicated at block 500. As mentioned this initial copy may be generated from copying data from a legacy system to a network data storage system of the present invention.

Once the initial copy of the data is present, referred to as the primary volume, a first primary snapshot is generated, as indicated at block 504. The first primary snapshot is created as previously discussed, and includes a copy of all of the pages of data from the primary volume. A data storage server, or data storage servers, are present locally to the data storage server(s) containing the primary volume, and connected to the data storage server(s) containing the primary volume through a high bandwidth link that is separate from the network used to connect the data storage server(s) to client applications and other management groups, thus reducing network overhead required for copying between the data storage server(s). At block 508, a remote volume and remote snapshot are created on the locally present data storage server(s), and the data from the primary snapshot is copied to the remote snapshot, as noted at block 512. At block 516, the data storage server(s), or at least the media from within the data storage server(s) containing the remote snapshot is removed to a remote location. At block 520, the remote volume and remote snapshot are generated and re-established with the primary volume and primary snapshot. In this manner, additional primary snapshots may be copied to associated remote snapshots at the remote location. The incremental copying required for each snapshot copy is in many cases requires significantly less data to be transferred through the network than a full copy of the entire source volume. The media that is transferred between the locations may include, for example, hard disk drives and tape data cartridges. Such media may be couriered to the remote location, or shipped on an expedited basis. The first remote snapshot may be generated from alternate data sources, such as tape data cartridges.

While the invention has been particularly shown and described with reference to embodiments thereof, it will be understood by those skilled in the art that various other changes in the form and details may be made without departing from the spirit and scope of the invention.

What is claimed is:

1. A system for use in providing data storage and data copies over a computer network, comprising:
a storage server system comprising one or more data storage servers that each comprise a data storage device and a network interface, each of said data storage servers operable to communicate over said network interface with at least one application client that will require data storage and at least one other data storage server; and
a data management system comprising at least one data management server operable to (a) define at least a first and a second cluster each comprising one or more data storage servers, (b) define at least one primary volume of data storage distributed over at least two of said storage servers within one of said clusters, said primary volume storing data from the application client, (c) define at least one remote volume of data storage distributed over one or more of said storage servers within one of said clusters; (d) create snapshots of said primary volume; and (e) copy data from said snapshots over the computer network to said remote volume.

2. The system for use in providing data storage and data copies over a computer network, as claimed in claim 1, wherein each of said snapshots provides a view of the data stored at said primary volume at the point in time of said snapshot.

3. The system for use in providing data storage and data copies over a computer network, as claimed in claim 1, wherein an application client is operable to read data stored in said snapshots at said primary volume.

4. The system for use in providing data storage and data copies over a computer network, as claimed in claim 1, wherein an application client is operable to read data stored in said snapshots at said remote volume.

5. The system for use in providing data storage and data copies over a computer network, as claimed in claim 1, wherein each snapshot includes data that has been modified at said primary volume since a previous snapshot of said primary volume.

6. The system for use in providing data storage and data copies over a computer network, as claimed in claim 5, wherein said snapshots are copied to remote snapshots associated with said remote volume.

7. The system for use in providing data storage and data copies over a computer network, as claimed in claim 5, wherein said snapshots are copied from said primary volume to said remote volume and at least a second remote volume distributed over one or more of said storage servers within one of said clusters.

8. The system for use in providing data storage and data copies over a computer network, as claimed in claim 5, wherein said snapshots are copied from said primary volume to said remote volume and at least a second remote volume distributed over one or more of said storage servers within one of said clusters, and wherein the source of said snapshots copied to said second remote volume is selected based on at least one of the volume most likely to be available, the least loaded volume, the volume with the highest bandwidth connection to the network, and the volume with a least costly connection to the network.

9. The system for use in providing data storage and data copies over a computer network, as claimed in claim 5, wherein said snapshots are copied from said primary volume to said remote volume and are copied from said remote volume to a second remote volume distributed over one or more of said storage servers within one of said clusters.

10. The system for use in providing data storage and data copies over a computer network, as claimed in claim 1, wherein said snapshots are created according to a predetermined schedule defined by said data management system.

11. The system for use in providing data storage and data copies over a computer network, as claimed in claim 10, wherein said snapshots are copied to remote snapshots associated with said remote volume according to said predetermined schedule.

12. The system for use in providing data storage and data copies over a computer network, as claimed in claim 1, wherein said data management system is further operable to designate said primary volume as a second remote volume that is not able to write data from application clients.

13. The system for use in providing data storage and data copies over a computer network, as claimed in claim 1, wherein said data management system is further operable to designate said remote volume as a second primary volume, said second primary volume storing data from at least one application client independently of said primary volume.

14. The system for use in providing data storage and data copies over a computer network, as claimed in claim 13, wherein said remote volume is designated as said second primary volume following a failure of said primary volume.

15. The system for use in providing data storage and data copies over a computer network, as claimed in claim 13, wherein said remote volume is designated as said second primary volume following a determination by a user to create a second primary volume.

16. The system for use in providing data storage and data copies over a computer network, as claimed in claim 13, wherein said data management system is further operable to designate said primary volume as a second remote volume that is not able to write data from application clients.

17. The system for use in providing data storage and data copies over a computer network, as claimed in claim 16, wherein said data management system is operable to copy data from a snapshot of said second primary volume to said second remote volume.

18. The system for use in providing data storage and data copies over a computer network, as claimed in claim 17, wherein said data management system is operable to generate a snapshot of said primary volume prior to designating said primary volume as said second remote volume.

19. The system for use in providing data storage and data copies over a computer network, as claimed in claim 18, wherein said data management system is operable to resynchronize said primary volume with said second primary volume.

20. The system for use in providing data storage and data copies over a computer network, as claimed in claim 1, wherein said primary volume comprises a plurality of logical blocks of data.

21. The system for use in providing data storage and data copies over a computer network, as claimed in claim 20, wherein each of said plurality of logical blocks of data comprises a plurality of physical blocks of data, each physical block of data comprising a unique physical address associated with said data storage device and data to be stored at said unique physical address.

22. The system for use in providing data storage and data copies over a computer network, as claimed in claim 20, wherein said snapshots comprise pointers to logical blocks of data stored at said cluster.

23. The system for use in providing data storage and data copies over a computer network, as claimed in claim 20, wherein
wherein each of said logical blocks of data are copied from said primary volume to said remote volume and at least a second remote volume distributed over one or more of said storage servers within one of said clusters, and wherein the source of each of said logical blocks of data copied to said second remote volume is selected based on at least one of the volume most likely to be available, the least loaded volume, the volume with the highest bandwidth connection to the network, and the volume with a least costly connection to the network.

24. The system for use in providing data storage and data copies over a computer network, as claimed in claim 1, wherein said network interface is adapted to connect to one of an Ethernet network, a fibre channel network, and an infiniband network.

25. The system for use in providing data storage and data copies over a computer network, as claimed in claim 1, wherein said data management system is operable to copy data from said snapshots to said remote volume independently of network protocol.

26. The system for use in providing data storage and data copies over a computer network, as claimed in claim 1, wherein said data management system is operable to copy data from said snapshots to said remote volume independently of network link bandwidth.

27. The system for use in providing data storage and data copies over a computer network, as claimed in claim 1, wherein said data management system is operable to copy data from said snapshots to said remote volume independently of network latency.

28. The system for use in providing data storage and data copies over a computer network, as claimed in claim 1, wherein said data management system is operable to copy data from said snapshots to said remote volume at a selected maximum bandwidth.

29. The system for use in providing data storage and data copies over a computer network, as claimed in claim 28, wherein said selected maximum bandwidth is adaptively set based on the network bandwidth capacity and utilization of the network.

30. The system for use in providing data storage and data copies over a computer network, as claimed in claim 28, wherein said selected maximum bandwidth is adjusted based on time of day.

31. The system for use in providing data storage and data copies over a computer network, as claimed in claim 1, wherein said first primary volume is located at a first cluster and said first remote volume is located at a second cluster.

32. The system for use in providing data storage and data copies over a computer network, as claimed in claim 31, wherein said first cluster and said second cluster are located at different geographic locations.

33. The system for use in providing data storage and data copies over a computer network, as claimed in claim 1, wherein said data management server is a distributed data management server distributed over one or more data storage servers.

34. The system for use in providing data storage and data copies over a computer network, as claimed in claim 1, wherein said data management server is further operable to redefine said primary volume to be distributed over one or more data storage servers that are different than said at least two data storage servers while copying data from said snapshots over the computer network to said remote volume.

35. The system for use in providing data storage and data copies over a computer network, as claimed in claim 1, wherein said data management server is further operable to define at least one replica volume of data storage distributed over one or more of said data storage servers within one of said clusters, said replica volume storing data stored at said primary volume.

36. The system for use in providing data storage and data copies over a computer network, as claimed in claim 35, wherein said data management server is operable to create snapshots of said replica volume corresponding to said snapshots of said primary volume, and wherein the source of said snapshots copied to said remote volume selected based on at least one of the volume most likely to be available, the least loaded volume, the volume with the highest bandwidth connection to the network, and the volume with a least costly connection to the network.

37. The system for use in providing data storage and data copies over a computer network, as claimed in claim 35, wherein in the event of a failure associated with said primary volume, said data management server is operable to copy said snapshots from said replica volume to said remote volume.

38. The system for use in providing data storage and data copies over a computer network, as claimed in claim 37, wherein said failure is at least one of a data storage server failure and a network failure.

39. A method for copying data from a primary data storage volume to a remote data storage volume in a distributed data storage system, comprising:
defining a first primary volume of data storage distributed over at least two data storage servers within a first cluster of data storage servers;
generating a first primary snapshot of said first primary volume, said first primary snapshot providing a view of data stored at said first primary volume at the time said first primary snapshot is generated;
creating a first remote volume distributed over one or more data storage servers within a cluster of data storage servers;
linking said first remote volume to said first primary volume; and
copying data from said first primary snapshot to a first remote snapshot associated with said first remote volume.

40. The method for copying data from a primary data storage volume to a remote data storage volume in a distributed data storage system, as claimed in claim 39, further comprising:
generating a second primary snapshot of said first primary volume, said second primary snapshot providing a view of data stored at said first primary volume at the time said second primary snapshot is generated; and
copying data from said second primary snapshot to a second remote snapshot associated with said first remote volume.

41. The method for copying data from a primary data storage volume to a remote data storage volume in a distributed data storage system, as claimed in claim 39, wherein said second primary snapshot includes data that has been modified at said first primary volume since said step of generating a first primary snapshot.

42. The method for copying data from a primary data storage volume to a remote data storage volume in a distributed data storage system, as claimed in claim 39, further comprising:
copying data from said first snapshot to a second remote volume distributed over one or more storage servers within a cluster of data storage servers.

43. The method for copying data from a primary data storage volume to a remote data storage volume in a distributed data storage system, as claimed in claim 39, further comprising:
copying said first remote snapshot from said first remote volume to a second remote volume distributed over one or more storage servers within a cluster of data storage servers.

44. The method for copying data from a primary data storage volume to a remote data storage volume in a distributed data storage system, as claimed in claim 39, wherein said steps of generating first and second primary snapshots are performed according to a predetermined schedule defined by a data management system.

45. The method for copying data from a primary data storage volume to a remote data storage volume in a distributed data storage system, as claimed in claim 39, wherein said steps of copying said first and second primary snapshots to said first and second remote snapshots are performed according to a predetermined schedule defined by a data management system.

46. The method for copying data from a primary data storage volume to a remote data storage volume in a distributed data storage system, as claimed in claim 39, further comprising:
designating said first remote volume as a second primary volume, said second primary volume storing data from at least one application client independently of said first primary volume.

47. The method for copying data from a primary data storage volume to a remote data storage volume in a distributed data storage system, as claimed in claim 46, wherein said step of designating is performed following a failure of said first primary volume.

48. The method for copying data from a primary data storage volume to a remote data storage volume in a distributed data storage system, as claimed in claim 47, wherein said step of designating is performed following a determination by a user to create a second primary volume.

49. The method for copying data from a primary data storage volume to a remote data storage volume in a distributed data storage system, as claimed in claim 48, further comprising:
designating said first primary volume as a second remote volume that is not able to write data from application clients.

50. The method for copying data from a primary data storage volume to a remote data storage volume in a distributed data storage system, as claimed in claim 49, further comprising:
copying data written to said second primary volume to said second remote volume.

51. The method for copying data from a primary data storage volume to a remote data storage volume in a distributed data storage system, as claimed in claim 49, wherein said step of designating said first primary volume as a second remote volume comprises:
generating a snapshot of said first primary volume; and
designating said first primary volume as said second remote volume.

52. The method for copying data from a primary data storage volume to a remote data storage volume in a distributed data storage system, as claimed in claim 49, further comprising resynchronizing said second primary volume with said second remote volume.

53. The method for copying data from a primary data storage volume to a remote data storage volume in a distributed data storage system, as claimed in claim 52, wherein said step of resynchronizing comprises:
generating a second primary snapshot of said second primary volume providing a view of data stored at said second primary volume at the time said second primary snapshot is generated;
generating a second remote snapshot of said second remote volume providing a view of data stored at said first primary volume at the time said third primary snapshot is generated;
copying data that has been modified at said second primary volume to said second remote volume.

54. The method for copying data from a primary data storage volume to a remote data storage volume in a distributed data storage system, as claimed in claim 39, wherein said step of creating a first remote volume comprises:
creating a volume at a cluster of data storage servers;
designating said volume as a remote volume;
linking said remote volume to said first primary volume; and
setting a maximum bandwidth at which data may be copied to said remote volume.

55. The method for copying data from a primary data storage volume to a remote data storage volume in a distributed data storage system, as claimed in claim 54, wherein said step of setting is based on network bandwidth capacity and network utilization.

56. The method for copying data from a primary data storage volume to a remote data storage volume in a distributed data storage system, as claimed in claim 54, wherein said step of setting comprises:
scheduling a maximum bandwidth at which data may be copied to said remote volume.

57. The method for copying data from a primary data storage volume to a remote data storage volume in a distributed data storage system, as claimed in claim 56, wherein said step of scheduling is based on at least one of time of day and day of the week.

58. The method for copying data from a primary data storage volume to a remote data storage volume in a distributed data storage system, as claimed in claim 39, wherein said data management system is a distributed data management server distributed over one or more of said data storage servers.

59. The method for copying data from a primary data storage volume to a remote data storage volume in a distributed data storage system, as claimed in claim 39, wherein said primary volume comprises a plurality of logical blocks of data, and wherein said step of generating a first primary snapshot comprises moving a pointer associated with each of said plurality of logical blocks of data from said primary volume to said first primary snapshot.

60. The method for copying data from a primary data storage volume to a remote data storage volume in a distributed data storage system, as claimed in claim 39, wherein said step of copying comprises:
copying a first portion of said first primary snapshot to said first remote snapshot; recording that said first portion has been copied; and copying a second portion of said first primary snapshot to said first remote snapshot.

61. The method for copying data from a primary data storage volume to a remote data storage volume in a distributed data storage system, as claimed in claim 60, wherein said step of copying a second portion is interrupted, and said step of copying a second portion is re-started based on said step of recording.

62. The method for copying data from a primary data storage volume to a remote data storage volume in a distributed data storage system, as claimed in claim 60, wherein the amount of data included in said first portion is based on an amount of data contained in said first primary snapshot.

63. The method for copying data from a primary data storage volume to a remote data storage volume in a distributed data storage system, as claimed in claim 60, wherein the amount of data included in said first portion is determined based on an elapsed time period since starting said step of copying a first portion.
